(19) United States
(12) Patent Application Publication
(10) Pub. No.: US 2008/0135041 A1
(43) Pub. Date: Jun. 12, 2008

(54) Kitchen ventilator system

(75) Inventor: Russell Robison, Yamhill, OR (US)

Correspondence Address: GREER, BURNS & CRAIN, LTD., 300 S. WACKER DRIVE, SUITE 2500, CHICAGO, IL, 60606, US

(73) Assignee: Illinois Tool Works Inc.

(21) Appl. No.: 11/637,338

(22) Filed: Dec. 12, 2006

(51) Int. Cl. F24C 15/20; B65D 69/00; G21G 5/00

(52) U.S. Cl. 126/299 D; 206/573; 250/492.1

(57) ABSTRACT

A ventilator assembly for removing contaminants in cooking exhaust includes a hood portion having a hood plenum, and a duct portion in fluid communication with the hood portion, where the duct portion has an inside cross-sectional area that is less than half of an average inside cross-sectional area of the hoodplenum. A fan is in fluid communication with the duct portion for drawing the cooking exhaust through the hood portion to the duct portion. At least one ultra-violet lamp is disposed in the duct portion, where the ultra-violet radiation from the lamp reacts with the cooking exhaust to generate ozone for oxidizing contaminants in the cooking exhaust.

### BACKGROUND OF THE INVENTION

The present invention relates generally to exhaust systems used in commercial kitchens, and more particularly, to kitchen ventilator systems that use ultra-violet light for reacting with air laden with grease, smoke, fumes and moisture rising from various types of cooking units.

Kitchen ventilator systems typically include a hood mounted above the cooking appliances for capturing cooking exhaust. In a commercial kitchen, for example, there are usually a number of cooking units lined up side-by-side in a row. Some of these cooking units, such as broilers and fryers, produce considerable quantities of cooking exhaust. The ventilator hood typically includes an inlet opening above the cooking units for capturing the cooking exhaust.

Conventionally, kitchen ventilator systems incorporate mechanical removal devices, such as extraction baffles, filters and particulate separators disposed in the flow path of the cooking exhaust. The filters and particulate separators remove grease particulate from the cooking exhaust, and the baffles create a winding flow path, which causes a mechanical, centrifugal grease extraction from the cooking exhaust. Conventional kitchen ventilator systems are typically dry systems or, alternatively, can include water wash systems to wash down the components inside the hood.

In a known dry ventilator system, the hood includes a high efficiency filter or a baffle with a particulate separator at the inlet to the hood. The cooking exhaust is filtered at the inlet and then travels upwards towards a duct. A damper is disposed at a duct collar and is movable between open and closed positions. When a high temperature is sensed in the hood that is possibly indicative of a fire condition, the damper is automatically closed.

In a known water wash ventilator system, the hood has a movable damper in a lower section of the ventilator hood near the inlet opening, and can be pivoted between open and closed positions depending on whether cooking exhaust through the ventilator system is desired. Inside the ventilator hood is a hood plenum having multiple extraction baffles that direct the cooking exhaust through the plenum. The winding path of the cooking exhaust around the baffles mechanically removes a large portion of the grease particulate from the cooking exhaust. In some installations, there is typically a particulate separator provided downstream of the baffles to further filter and remove grease particulate. A nozzle is disposed in the ventilator hood and sprays water down onto the grease extraction baffles.

Ultra-violet (UV) lamps are conventionally located in the hood plenum upstream of the extraction baffles and the particulate separator, typically in one or more UV light frames, depending on the ventilator length. Radiation from the UV lamps causes ozone to be generated from oxygen that is present in the exhaust air. The ozone, in turn, oxidizes the organic contaminants, such as the grease particulate.

There are several factors that dictate placement of the UV lamps in the ventilator system. First, the UV lamps emit a large amount of UV radiation, and as such, the UV lamps must be positioned in the ventilator system to avoid user exposure. Further, since other safety components are also typically located in the hood adjacent the UV lamps, the hood has to accommodate these components as well. Further, the UV lamps must be positioned to permit adequate exposure of UV radiation to the cooking exhaust. It is believed by many skilled in the art that above certain exhaust velocities, the UV radiation has limited effectiveness in removal of particulate. In other words, it is believed that the cooking exhaust must have an adequate exposure time to the UV radiation as the exhaust flow path crosses the UV lamps.

For these reasons, the UV lamps have conventionally been located in the hood plenum, where cooking exhaust velocities are relatively lower than in other portions of the ventilation system. However, in updating existing ventilation systems, it is difficult to retrofit new UV lamps into the hood plenum, given the limited space constraints inside the hood plenum. Further, in locating the UV lamps in the hood plenum, the UV lamps must be positioned in the ventilator system to avoid user exposure.

Thus, there is a need for an improved kitchen ventilator system having UV lamps that sufficiently extract grease particulate.

There is a further need for UV lamps that can be easily retrofitted into an existing kitchen ventilation system.

### BRIEF SUMMARY OF THE INVENTION

The above-listed needs are met or exceeded by the present ventilator assembly for removing contaminants in cooking exhaust that includes at least one UV lamp mounted in an easily accessible location, and that also provides an adequate amount of UV radiation. In a preferred embodiment, the UV lamps are provided as a multi-lamp unit readily retrofitted into an existing ventilation duct located above the hood. Also, a wash system is contemplated which periodically cleans the UV lamps when the hood is cleaned.

A ventilator assembly for removing contaminants in cooking exhaust includes a hood portion, and a duct portion in fluid communication with the hood portion, where the duct portion has an inside cross-sectional area that is less than half of an inside cross-sectional area of the hood portion. A fan is in fluid communication with the duct portion for drawing the cooking exhaust through the hood portion to the duct portion. At least one ultra-violet lamp is disposed in the duct portion, where the ultra-violet radiation from the lamp reacts with the cooking exhaust to generate ozone for oxidizing contaminants in the cooking exhaust.

In an alternate ventilator assembly at least partially disposed above a ceiling, the fan is in fluid communication with the duct portion for drawing the cooking exhaust through the hood portion to the duct portion, and the fan draws the cooking exhaust through the duct at a duct flowrate. At least one ultra-violet lamp disposed in the duct portion generates ultra-violet radiation to react with the cooking exhaust to generate ozone for oxidizing contaminants in the cooking exhaust. The lamp requires a minimal amount of input power to generate adequate ultra-violet radiation, where the minimum amount of power is determined as a function of the duct flowrate.

Another embodiment of a ventilator assembly for removing contaminants in cooking exhaust includes a duct wash manifold located upstream of at least one ultra-violet lamp for cleaning the at least one ultra-violet lamp.

Also provided is a kit for retrofitting a ventilator system having a hood portion, a duct portion in fluid communication with the hood portion, and a fan in fluid communication with the duct portion for drawing the cooking exhaust through the hood portion to the duct portion, where the duct portion has an opening in a first side wall. The kit includes at least one ultra-violet lamp disposed in a first surface of a module, where the lamp is configured to be introduced into the opening in the duct portion to extend from a first surface of the module substantially to a second side wall. The module is configured to be fastened to an exterior surface of a first side wall to enclose the opening. An outer housing is configured to be fixed to the exterior surface of the duct portion and is configured for preventing access to the first surface of the module.

### BRIEF DESCRIPTION OF THE DRAWINGS

FIG. 1 is a perspective view of the present ventilation system, with a duct portion cut-away to expose a UV module;

FIG. 2 is a schematic section view of the present ventilation system of FIG. 1 in the exhaust cycle;

FIG. 3 is a schematic section view of the present ventilation system of FIG. 1 in the wash cycle; and

FIG. 4 is a fragmentary vertical section view of the present ventilation duct equipped with the present UV module; and

FIG. 5 is a schematic section view of an alternate ventilation system.

### DETAILED DESCRIPTION OF THE INVENTION

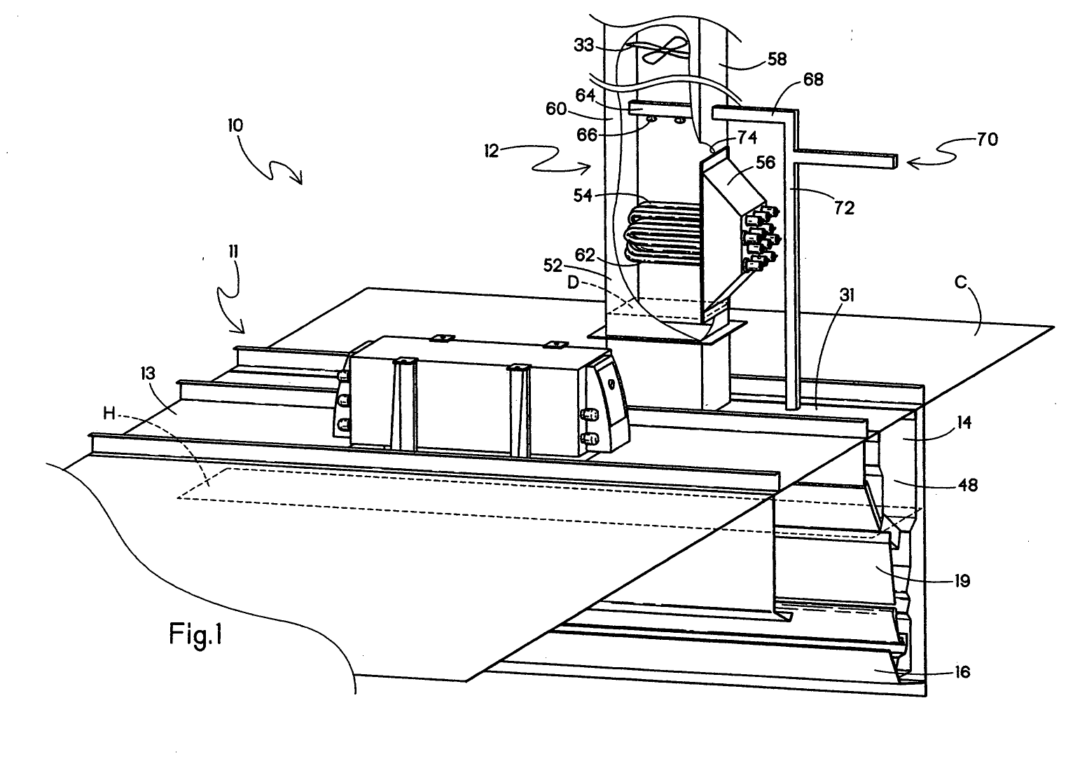

Referring to FIG. 1, a ventilator assembly 10 is shown in perspective view with part of the right side cut away. The ventilator assembly 10 has a hood portion, indicated generally at 11, which is typically positioned above a large commercial cooking area (not shown) that may include one or more cooking stations such as a griddle, range, fryer, and/or broiler, and is typically mounted to a wall or hung from the ceiling (not shown) over the cooking area. Unless otherwise indicated, the following description is made with reference to the ventilator assembly 10 of FIGS. 1-3, which is of the type that includes an optional water wash system in the hood portion 11. However, it is contemplated that other ventilator assemblies having different hood portions can be used, some lacking such water wash systems.

A duct portion, indicated generally at 12, is located on the upstream side of the hood portion 11 and is in fluid communication with the hood portion. At least a portion of the duct portion 12 is preferably located above a ceiling “C” of a facility, such as a commercial kitchen or restaurant, and in the preferred embodiment, the entire duct portion is located above the ceiling “C”.

The ventilator assembly 10 includes an outer housing 13 encompassing an interior hood plenum 14. As is known in the art, such assemblies are typically fixed to a wall and/or suspended from ceiling trusses (not shown). Included on the hood plenum 14 is a lower panel 16 and an upper panel 18 at a front side 19 which define a module slot 20 for receiving one or more access doors 22. The ventilator assembly 10 is preferably constructed of stainless steel, and more preferably constructed of a stainless steel of not less than 18 gauge, series 300.

In the hood plenum 14, there is at least one grease extraction baffle 24. In the preferred embodiment, three grease extraction baffles 24A, 24B, 24C protrude inwardly from the walls of the hood plenum 14 and define a flowpath “F” of the cooking exhaust through the hood portion 11. In addition, the grease extraction baffles 24 preferably alternate to create a winding flow path, which causes a mechanical, centrifugal grease extraction from the cooking exhaust. The grease extraction baffles 24 are sloped to collect and drain the extracted grease particulate out of the hood plenum 14.

An air inlet slot 26 is provided at a lower section 28 of the hood portion, below the modules 22. In the illustrated embodiment, the air inlet slot 26 is defined by the lower panel 16 and a lower portion 29 of the modules 22. The air inlet slot 26 is typically positioned over the top of the cooking stations to capture the cooking exhaust.

An exhaust outlet 30 of the hood plenum 14 is located along a top portion 31 of the hood portion 14. The exhaust outlet 30 is in fluid communication with the duct portion 12. In this configuration, the flow path “F” through the ventilator assembly 10 extends from the air inlet slot 26, up through the interior of the hood plenum, past the grease extraction baffles 24, to an upper section 32 of the hood plenum 14 and to the exhaust outlet 30, which leads to the duct portion 12. The duct portion 12 connects to appropriate exhaust ductwork (not shown), which typically has a fan 33 for pulling gases through the ventilator assembly 10.

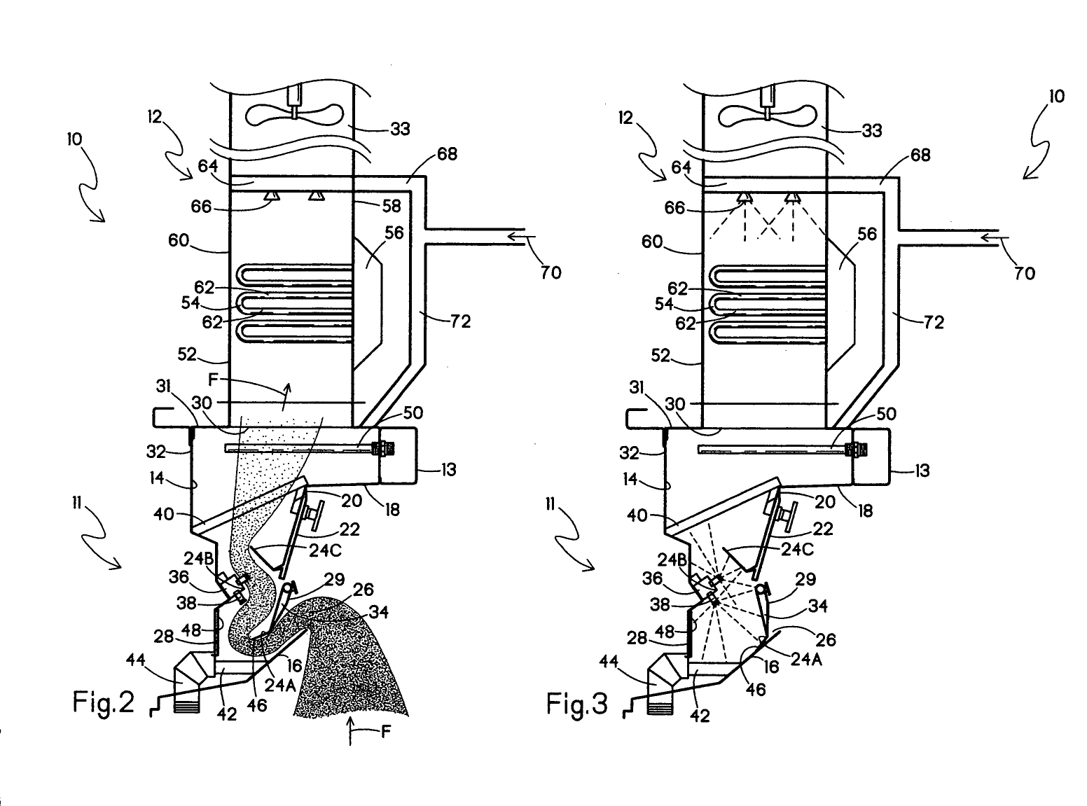

In the ventilator assembly 10 of FIGS. 2 and 3, a multi-position damper 34 is located within the lower section 28 of the hood structure 14 and is positionable in both an “exhaust cycle” position for allowing gases to flow freely along the flow path “F”, and a “wash cycle” position for preventing the free flow of gases through the ventilator assembly 10. Other positions of the damper are contemplated, and the term “multi-position damper” as used herein refers to a damper 34 which may be moved between two or more positions.

As seen in FIG. 2, the first position of damper 34 is the “exhaust cycle” position, where the fan 33 is on and the damper is pivoted inwardly towards inside of the hood plenum 14 to create the flow path “F” for the cooking exhaust. In this configuration, the damper 34 itself acts as a grease extraction baffle.

Referring now to FIG. 3, the second position is the “wash cycle” position, where the damper 34 is pivoted generally outwardly towards the lower panel 16 so to be positioned across the inlet slot 26 and impede the flow path “F” (See FIG. 3). When in the “wash cycle” position, the exhaust fan 33 is shut off, and the flow of cooking exhaust into the hood plenum 14 is prevented.

In ventilator assemblies equipped with water wash systems, it is common to periodically clean the ventilator assembly 10 using a combination of hot water and a cleaning agent by feeding the combined water/cleaning agent internally to the hood portion 11. Inside the hood plenum 14, a wash manifold 36 including at least one spray nozzle 38 provides water (shown schematically as broken lines in FIG. 3), to remove the accumulation of extracted grease from the extraction baffles 24. A particulate filter or separator 40 is preferably located upstream of the baffles 24, and is also cleaned by the water emitted from the spray nozzle 38.

A gutter 42 is preferably located at the lower section 28 of the hood portion 11, and has a slight incline to collect and drain the water and grease. The collected water exits the hood plenum 14 through a drainpipe 44.

A third position is the “fire cycle” position (not shown). The damper 34 is pivoted such that a distal end 46 of the damper is positioned against a rear surface 48 of the hood plenum 14 underneath the wash manifold 36 to prevent flow of gases through the hood portion 11 to the duct portion 12. The positioning of the damper 34 in the “fire cycle” position aids in preventing the spread of fire to the duct portion 12. In this configuration, the rear surface 48 of the upper panel 18 forms a contact surface against which the distal end 46 of the damper 34 is positioned to prevent the flow of gases and the spread of fire through the ventilator assembly 10.

A temperature sensor 50, such as a thermostat for example, is positioned in the upper section 32 of the hood portion 11. The temperature sensor 50 monitors the temperature within the hood plenum 14 near the exhaust outlet 30. The sensor 50 preferably provides an output to a controller (not shown), which is connected to the damper 34, to pivot the damper into the “fire cycle” position when a temperature in the ventilator assembly 10 exceeds a threshold temperature that may be indicative of a fire.

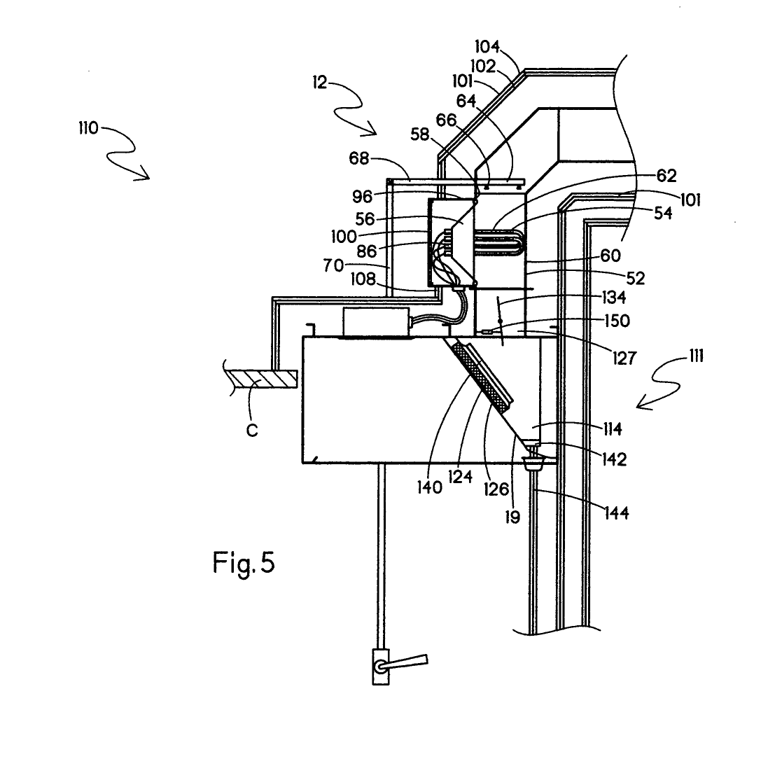

Referring now to FIG. 5, an alternate ventilator assembly 110 is shown and described, with components shared with the ventilator assembly 10 designated with numbers in the 100-series. The ventilator assembly 110 does not include a water wash system in a hood portion 111, although the water wash system is an optional component. The hood portion 111 includes a hood plenum 114 having a high efficiency filter or a baffle 124 with a particulate separator 140 that is disposed generally parallel to the baffle, both of which are located at or near an inlet 126 to the hood plenum. The cooking exhaust is filtered at the baffle 124 and the particulate separator 140, and then travels upwards towards a duct portion 12. A damper 134 is disposed at a duct collar 127 and is movable between open and closed positions. When a predetermined high temperature is sensed in the duct collar 127, preferably with a fuse link 150, the damper 134 is automatically closed. A gutter 142 and a drainpipe 144 are disposed at the lower end of the hood plenum 114. While the ventilator assemblies 10 and 110 having hood portions 11 and 111 have been described, it is contemplated that the invention is not limited to these particular assemblies, but that other ventilator assemblies can be used.

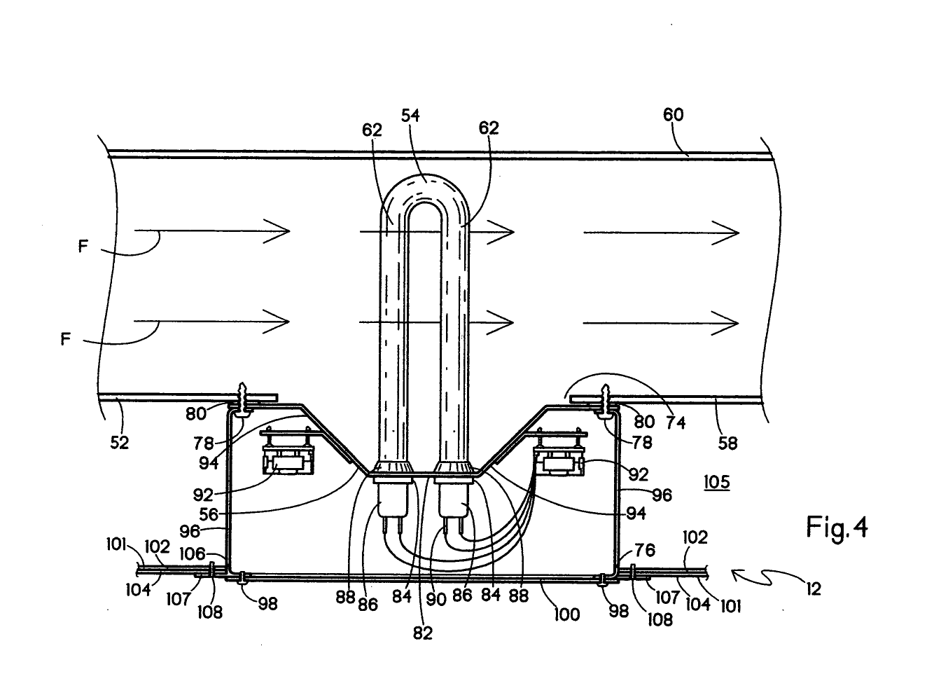

Referring now to FIGS. 1 and 4, the duct portion 12 includes a duct shaft 52, preferably having a generally rectangular cross-section “D” that is preferably less than half the cross-sectional area of the average cross-section of the hood plenum “H” (FIG. 1). The cross-section “D” of the duct shaft 52 generally corresponds to the average cross-sectional area of the duct shaft taken generally transverse to the flowpath “F”. The average cross-section “H” generally corresponds to the average cross-sectional area of the hood plenum 14 taken generally parallel to the ceiling “C”, generally transverse to the flowpath “F”, and extending from a front side 19 to the rear surface 48 of the hood plenum.

Standard duct shaft 52 sizes include 12-inch by 24-inch, 10-inch by 10-inch, and 36-inch by 18-inch, although other duct shaft sizes are contemplated. As is known in the art, the duct shaft 52 may extend toward other exhaust duct work (not shown) for venting the cooking exhaust to a remote location.

Referring now to FIGS. 1-5, disposed inside the duct shaft 52 is at least one ultra-violet (UV) lamp 54. Preferably, there are a plurality of UV lamps 54 disposed in a module 56, and the UV lamps preferably extend from a first side wall 58 of the duct shaft substantially to a second, opposite side wall 60 of the duct shaft 52. Preferably, the UV lamps 54 have a general “U”-shape. An advantage to using the “U”-shaped lamp 54 instead of a linear lamp is that the “U”-shaped lamp gives the same radiation output (Lumens) from half the length and is thus easier to fit within the duct shaft 52.

Preferably, the UV lamps 54 extend generally transverse to the flowpath “F” of the cooking exhaust in the duct shaft 52, and more preferably, are oriented to allow flow of cooking exhaust between the legs 62 of the “U”-shape. In the preferred embodiment, there are six 37-Watt UV lamps 54, for a total input of about 222-Watts of power. However, the number and arrangement of the lamps 54 may vary to suit the application.

Radiation from the UV lamps 54 is used to react with grease particulate. Specifically, UV radiation having a wavelength of approximately 185 nm causes ozone to be generated from oxygen that is present in the cooking exhaust, and the ozone oxidizes organic contaminants in the cooking exhaust, such as the grease particulate.

In the prior art, the UV-lamps 54 are positioned in the hood plenum 14 since the velocity of the cooking exhaust inside the plenum is lower than the velocity inside the duct shaft 52. For example, the cooking exhaust velocity in the hood plenum 14 is typically about 300 ft/min across the lamps, and the velocity in the duct shaft 52 is typically about 1800 ft/min. The conventional thinking by those skilled in the art is that the cooking exhaust must have a certain amount of exposure time to the radiation for the ozone to be generated. For that reason, the conventional thinking is that the speed of the cooking exhaust at the time it is exposed to the UV lamp must be below a certain speed. To expose the cooking exhaust to the UV radiation at a low velocity, the UV lamps are conventionally placed in the hood plenum 14. An example of such a configuration is U.S. Pat. No. 6,787,195.

However, in testing conducted on the present ventilator assembly 10, it was found that placing the UV lamps 54 in the duct shaft 52 results in similar ozone production as placing the UV lamps in the hood plenum 14, even though the cooking exhaust has a significantly higher velocity in the duct shaft. In Test 1, below, the ozone production was measured as a function of temperature in the duct shaft 52 under both medium and heavy duty loading conditions. The medium loading data was taken using a griddle, and the heavy duty loading data was taken using a char broiler. The exhaust flow rate through the duct shaft 52 was approximately 250 CFM/LF (cubic feet per minute per linear foot). The power output from the standard plenum mounted system included six 39-Watt lamps (for a total of 234 Watts), and the power output from the duct mounted system included six 37-Watt lamps (for a total of 222 Watts). Below is a table of ozone concentration readings taken downstream of the UV lamps at selected temperatures. The ozone concentration readings translate to reaction with organics, such as grease, where higher ozone concentrations translate to higher reaction with organics:

TEST 1

| Temperature (° F.) | Plenum O3 Conc. (PPM) | Duct O3 Cone. (PPM) |
|---|---|---|
| 87 | 0.39 | |
| 88 | | 0.41 |
| 92 | | 0.44 |
| 94 | 0.46 | |
| 98 | | 0.49 |
| 99 | 0.46 | |
| 107 | | 0.45 |
| 108 | 0.46 | |

Since ozone production was believed to be a function of the amount of UV radiation per velocity of the exhaust, the results between the plenum mounted UV lamps and the duct mounted UV lamps 54 should be significantly different, since the UV lamps experience a significantly higher velocity of exhaust gas at the duct shaft 52 than at the plenum 14. However, Test 1 indicated unexpected results. Specifically, Test 1 indicated that the duct mounted UV-lamp ventilator assembly 10 yielded similar ozone production to the conventional plenum mounted UV lamp ventilator assembly. This is contrary to the conventional thinking that sufficient ozone creation could not be accomplished at the high velocities reached in the duct shaft 52.

As a result of Test 1 and similar testing, it is believed that ozone production is not adverserly affected by the velocity, but is instead mostly a function of the volumetric flowrate. Specifically, it is believed that an adequate amount of UV radiation (Lumens) per volumetric flowrate (CFM) is required. To produce an adequate amount of UV radiation for any given rated UV lamp, an adequate amount of input power (Watts) must be delivered to the UV lamps. In the preferred embodiment, using the six 37-Watt “U′-shaped lamps, the ratio of input power to airflow is about 0.15 to 0.25, with a most preferred ratio of about 0.22 (W/CFM).

Referring to FIG. 2, since the UV lamps 54 are disposed in the path “F” of airflow and accompanying grease particulate, the lamps require periodic cleaning to remove the build-up of grease on the lamps. A duct wash manifold 64 having at least one spray nozzle 66 is disposed above the module 56. A supply line 68 feeds water to the spray nozzle 66 from a water wash plumbing loop 70. Preferably, the water wash plumbing loop 70 also feeds water to a second supply line 72 that supplies water to the wash manifold 36 disposed in the hood portion 11.

When the wash cycle is implemented, the water from the duct wash manifold 64 cleans the UV lamps 54 and drains down into the hood portion 11. The water is preferably drained at the drainpipe 44, however it is contemplated that the water can be drained at other locations.

The wash cycle may be implemented on a timed basis or manually at the direction of the user. Also, it is contemplated that the washing cycle may occur simultaneously or separate from the wash manifold 36 in the hood portion 11.

Referring now to FIGS. 1 and 4, the duct shaft 52 has an opening 74 for receiving the module 56, which is mounted into the duct shaft at the first side wall 58. In FIG. 4, the module 56 has an outer housing 76 for enclosing the module, and in FIG. 1, the outer housing is shown removed. The module 56 including the outer housing 76 is preferably made of stainless steel or a similar material.

As seen in FIG. 4, the module 56 is fastened into the first side wall 58 of the duct shaft 52 with a first fastener 78, preferably a sheet metal screw, at a plurality of locations. Between the first side wall 58 and the module 56 at the first fastener 78, a sealer/gasket 80 may be disposed for sealing and dampening vibrations transmitted from the duct shaft 52 to the module 56. The sealer/gasket 80 is preferably a composite of a vermiculite gasket used for a fire seal, and a silicone sponge used for a grease seal, however other sealer/gaskets may be used.

Preferably, the width and/or surface area “D” of the duct shaft 52 is generally constant along the length of the duct shaft, including at the location of the module 56. In the alternative, if the duct shaft 52 does not have a generally constant cross-sectional area, the area “D” should be taken at the location of the module 56. It is contemplated that the configuration of the module 56 in the opening 74 can create a slight increase or decrease in the width and/or surface area “D” of the duct shaft 52 at the location of the module 56.

In the duct shaft 52, the flowpath “F” is generally straight, and apart from the UV lamps extending into the flowpath, obstruction free. Further, since it has been found that retention time has little to no affect on ozone reaction, the flowrate through the duct shaft 52 is relatively much higher than with respect to the hood portion 11. For example, the cooking exhaust velocity in the hood plenum 14 is typically about 300 ft/min across the lamps, and the velocity in the duct shaft 52 is typically about 1800 ft/min. The module 56 includes a first surface 82 having a plurality of receiving apertures 84 for receiving the ends of the generally “U”-shaped lamps. In the preferred embodiment, there are twelve receiving apertures 84 for receiving both ends of the six UV lamps 54. At each end of the UV lamp 54 is a connector portion 86 that is sealingly attached to the first surface 82 of the module 56 with a rubber-like grommet or similar seal 88 to prevent the escape of cooking exhaust or water outside of the duct shaft 52.

Two direct wires 90 extend from the connector portion 86. As is known in the art, the wires 90 are electrically connected to a ballast member 92 to control the amount of current into the electric circuit. The ballast members 92 are preferably disposed on two side surfaces 94 of the module 56, however their location may vary to suit the application.

The outer housing 76 conceals the electrical components of the module 56 and provides a further light barrier from the UV lamps 54. It is preferred that the outer housing 76 includes multiple side panels 96 fastened to the module 56 using the first fastener 78 used to fasten the module to the first side wall 58. The side panels 96 create a barrier around the sides of the module 56. Fastened to the side panels 96 with a second fastener 98 is a front panel 100, which when removed, provides access to the electrical components and to the first fastener 78. To remove the module 56, the front panel 100 is removed by removing the second fasteners 98, and then the first fasteners 78 can be removed.

The duct shaft 52 is disposed within an outer shaft wrap 101, which preferably includes an inner 102 and an outer layer 104 of gypsum wallboard or other fire resistant material. The outer shaft wrap 101 encloses the duct shaft 52 around the perimeter of the duct shaft, preferably leaving a clearance 105 of about three to six inches on each side. An opening 106 is disposed in the outer shaft wrap 101 to locate the module 56 into the duct shaft 52. In the preferred embodiment, a flange 107 extends from the module 56 at both an upper and lower end, and is attached to the outer shaft wrap 101, preferably with at least one fastener such as a screw 108.

It is contemplated that the ventilator assembly 10 is equipped with a detection system (not shown) for detecting whether the lamps are working properly, such as by using a current monitor relay or other detection devices. Further, it is contemplated that the ventilator assembly 10 can include a second detection system (not shown) for detecting whether the particulate filter, the UV lamps and the outer housing components are in place, among other things. The second detection system can include pressure switches or other known detecting devices. Further, detection systems can also be provided to detect when the fan 33 is on.

With the UV lamp module 56 mounted in the duct portion 12, and particularly when the UV lamp is located in the duct portion 12 above the ceiling “C”, there is less likelihood of exposure to the UV radiation. Further, in updating existing ventilation systems, it is easier to retrofit a new UV module 56 and the outer housing 76 into the duct portion 12 than to place a new UV module into the hood plenum 14.

While particular embodiments of the present ventilator assembly 10 have been shown and described, it will be appreciated by those skilled in the art that changes and modifications may be made thereto without departing from the invention in its broader aspects and as set forth in the following claims.

1. A ventilator assembly for removing contaminants in cooking exhaust, comprising:
a hood portion having a hood plenum;
a duct portion in fluid communication with said hood portion, said duct portion having an inside cross-sectional area that is less than half of an average inside cross-sectional area of said hood plenum;
a fan in fluid communication with said duct portion for drawing the cooking exhaust through the hood portion to said duct portion; and
at least one ultra-violet lamp for generating ultra-violet radiation disposed upstream of said fan in said duct portion, wherein said duct portion is generally obstruction free upstream of said at least one ultra-violet lamp, wherein said ultra-violet radiation reacts with the cooking exhaust to generate ozone for oxidizing contaminants in the cooking exhaust.

2. The ventilator assembly of claim 1 wherein said duct portion has a generally constant cross-sectional area, and said duct is generally obstruction free at a mounting point of said at least one lamp, except for said at least one ultra-violet lamp.

3. The ventilator assembly of claim 1 wherein said at least one ultra-violet lamp is generally “U”-shaped.

4. The ventilator assembly of claim 3 wherein said at least one ultra-violet lamp comprises a plurality of lamps disposed in a module.

5. The ventilator assembly of claim 4 further comprising an outer housing enclosing said module.

6. The ventilator assembly of claim 3 wherein said at least one generally “U”-shaped lamp is positioned in said duct portion transverse to a flow path of the cooking exhaust such that the cooking exhaust flows between two legs of the generally “U”-shape, and said at least one generally “U”-shaped lamp is placed in an area of high velocity flow relative to air flow in said hood plenum.

7. A ventilator system for removing contaminants in cooking exhaust, comprising:
a hood portion;
a duct portion in fluid communication with said hood portion;
a fan in fluid communication with duct portion for drawing the cooking exhaust through the hood portion to said duct portion, wherein said fan draws the cooking exhaust through said duct portion at a duct flowrate;
at least one ultra-violet lamp for generating ultra-violet radiation disposed in said duct portion, wherein said ultra-violet radiation reacts with the cooking exhaust to generate ozone for oxidizing contaminants in the cooking exhaust, wherein said at least one ultra-violet lamp requires a minimal amount of output power to generate adequate ultra-violet radiation, wherein said minimum amount of output power is determined by said duct flowrate of the cooking exhaust.

8. The ventilator system of claim 7 wherein the ventilator system requires a ratio of said input power to said duct flowrate of about 0.15 to 0.25 Watts per cubic feet per minute (W/CFM) for effective removal of the contaminants.

9. The ventilator system of claim 8 wherein the ventilator system requires a ratio of said input power to said duct flowrate of about 0.22 Watts per cubic feet per minute (W/CFM).

10. A ventilator assembly at least partially disposed above a ceiling for removing contaminants in cooking exhaust, comprising:
a hood portion;
a duct portion in fluid communication with said hood portion, at least a portion of said duct portion being located above the ceiling;
a fan in fluid communication with said duct portion for drawing the cooking exhaust through the hood portion to said duct portion; and
at least one ultra-violet lamp for generating ultra-violet radiation disposed in said portion of said duct located above the ceiling, wherein said ultra-violet radiation reacts with the cooking exhaust to generate ozone for oxidizing contaminants in the cooking exhaust; and
a duct wash manifold located upstream of said at least one ultra-violet lamp for cleaning said at least one ultra-violet lamp.

11. The ventilator assembly of claim 10 wherein said duct wash manifold further comprises at least one spray nozzle.

12. The ventilator assembly of claim 10 further comprising a hood wash manifold disposed in said hood portion, and configured for cleaning the interior of said hood portion.

13. The ventilator assembly of claim 12 wherein said duct wash manifold may be initiated on a timed basis or manually at the direction of the user.

14. The ventilator assembly of claim 12 wherein said duct wash manifold and said hood wash manifold may be initiated simultaneously or separate from each other.

15. A kit for retrofitting a ventilator system having a hood portion, a duct portion in fluid communication with the hood portion, and a fan in fluid communication with the duct portion for drawing the cooking exhaust through the hood portion to the duct portion, said duct portion having an opening in a first side wall, comprising:
at least one ultra-violet lamp disposed in a first surface of a module, said at least one ultra-violet lamp configured to be introduced into the opening in the duct portion to extend from a first surface of said module substantially to a second side wall, said module configured to be fastened to an exterior surface of a first side wall to enclose the opening; and
an outer housing configured to be fixed to said exterior surface of said duct portion and configured for preventing access to said first surface of said module.

16. The kit of claim 15 wherein said at least one ultra-violet lamp is generally “U”-shaped.

17. The kit of claim 15 wherein said first surface of said module is configured to receive a plurality of generally “U”-shaped ultra-violet lamps, wherein each end of said plurality of ultra-violet lamps is received in said first surface.

18. The kit of claim 15 wherein said outer housing includes at least one side panel configured for attachment to said exterior surface of said first side wall, and at least one front panel configured for attachment to said at least one side panel.

19. The kit of claim 15 further comprising a duct wash manifold configured for placement in said duct portion upstream of said module.

20. The kit of claim 19 further comprising a supply line that is in fluid communication with said duct wash manifold to supply water from a water supply to said duct wash manifold.
